(19) United States
(12) Patent Application Publication
(10) Pub. No.: US 2025/0346300 A1
(43) Pub. Date: Nov. 13, 2025

(54) VEHICLE LOWER STRUCTURE

(71) Applicant: Mazda Motor Corporation, Hiroshima (JP)

(72) Inventors: Eiji KAMEMOTO, Aki-gun (JP); Hideyuki TSUKAMOTO, Aki-gun (JP); Isamu KIZAKI, Aki-gun (JP)

(73) Assignee: Mazda Motor Corporation, Hiroshima (JP)

(21) Appl. No.: 19/198,127

(22) Filed: May 5, 2025

(30) Foreign Application Priority Data
May 13, 2024 (JP) 2024-077657

(51) Int. Cl. B62D 25/20

(52) U.S. Cl. CPC B62D 25/2036

(57) ABSTRACT

In vehicle lower structure includes paired side sills on both sides in a vehicle width direction of the floor section and extending in a front-rear direction, and a frame member. The frame member includes plural first portions, and plural second portions. The plural first portions are spaced apart from each other in a front-rear direction and each extend in a vehicle width direction. Each of the plural second portions is connected to an end portion of a respective first portion, extends outward in the vehicle width direction, and are arranged in the front-rear direction. The plural second portions have a total length in the front-rear direction of end portions on each of outer sides in the vehicle width direction is longer than a total length in the front-rear direction of the plural first portions.

### CROSS-REFERENCE TO RELATED APPLICATION

The present application claims priority to Japanese application number 2024-077657 filed in the Japanese Patent Office on May 13, 2024, the entire contents of which are incorporated herein by reference.

### TECHNICAL FIELD

Embodiments relate to a vehicle lower structure and, in particular, to a lower structure of a floor section.

### BACKGROUND ART

As illustrated in FIG. 9, a vehicle according to the related art includes: paired side sills 910, which are arranged on both sides in a vehicle width direction of a floor section, and each of which extends in a front-rear direction; and plural cross members 911, each of which extends in the vehicle width direction in a manner to connect the paired side sills 910. In such a vehicle, when a load F9 from a lateral side is input between connection portions of the side sill 910 with the cross members 911 in the front-rear direction, a part of the load F9 is divided in a longitudinal direction of the side sill 910 (a load F91), and a part of the load F91 is input to the cross member 911 from the joint portion.

In Patent Literature 1, a configuration is disclosed that a bulkhead is arranged inside the side sill 910 in order to improve load absorption performance during a side collision.

### CITATION LIST

### Patent Literature

[Patent Literature 1] JP2021-91341A

### SUMMARY

### Technical Problems

However, in the vehicle according to the related art, the plural cross members 911, which are arranged at regular intervals in the front-rear direction, and each of which extends in the vehicle width direction, are connected to the right and left pair of side sills 910. However, an input load F9 during a side collision cannot be sufficiently transmitted to the cross members 911.

Depending on the input portion of the side collision load in the side sill 910, the input load is not easily distributed to an opposite side in the vehicle width direction from the input side in the vehicle according to the related art. Thus, the floor section cannot be protected sufficiently during the side collision in the vehicle according to the related art.

Embodiments are directed to providing a vehicle lower structure capable of sufficiently protecting a floor section even when an obstacle such as a pole collides from a side.

### Solutions to Problems

A vehicle lower structure according to an aspect of the disclosure is a lower structure of a floor section in a vehicle, and includes paired side sills and a frame member. The paired side sills are disposed on both sides in a vehicle width direction of the floor section and are each formed to extend in a front-rear direction. The frame member is disposed between the paired side sills.

The frame member has plural first portions, plural second portions, and paired third portions. The plural first portions are disposed at spaced intervals, e.g., mutually-spaced, i.e., at equal intervals, in the front-rear direction in a central portion in the vehicle width direction of the floor section, and are each formed to extend in the vehicle width direction. The plural second portions are each connected to an end portion of the respective first portion, are each formed to extend outward in the vehicle width direction, and are arranged in the front-rear direction. The paired third portions are each connected to the plural second portions on the outer side in the vehicle width direction, are each formed to extend in the front-rear direction along the respective side sill, and are each connected to the respective side sill.

In the vehicle lower structure according to the present aspect, the plural second portions are formed such that a total length in the front-rear direction of end portions on each of both outer sides in the vehicle width direction is longer than a total length in the front-rear direction of the plural first portions.

In the vehicle lower structure according to the above aspect, the frame member having the plural first portions and the plural second portions is disposed between the paired side sills. The plural second portions are formed such that the total length in the front-rear direction of the end portions on each of the outer sides in the vehicle width direction is longer than the total length in the front-rear direction of the plural first portions. Thus, compared to the above related art in which the end portion of the cross member is directly fixed to the side sill, the side collision load is highly efficiently transmitted to the first portions via the second portions even when a side collision load is input to the side sill from a portion within a wider range than that in the above related art.

That is, in the vehicle lower structure according to the above aspect, unlike the related art illustrated in FIG. 9 in which the cross member is directly fixed to the side sill, the second portions are connected to the respective side sill within the wider area in the front-rear direction than the first portions. Accordingly, even when the side collision load is input to the side sill from the portion within the wider area than that in the above related art, the input load is transmitted to the first portions via the second portions and is then distributed to the second portions on the opposite side from the input side. Therefore, in the vehicle lower structure according to the above aspect, it is possible to sufficiently protect the floor section even when an obstacle such as a pole collides from the side.

In the vehicle lower structure according to the above aspect, such a configuration may be adopted that the frame member further has the paired third portions, each of which is connected to the end portions of the plural second portions on the outer side in the vehicle width direction, and each of which is formed to extend in the front-rear direction along the respective side sill and connected to the respective side sill.

In the vehicle lower structure according to the above aspect, since the frame member has the third portion that is disposed along the side sill and between the second portion and the side sill, the load input to the side sill during a side collision is efficiently transmitted to the second portion via the third portion.

In the vehicle lower structure according to the above aspect, each adjacent pair of the second portions in the front-rear direction is connected to each other in a connection portion with the respective third portion.

In the vehicle lower structure according to the above aspect, since each adjacent pair of the second portions in the front-rear direction is connected to each other in the connection portion with the respective third portion, the side collision load that is input from the side sill to the third portion can be distributed to each adjacent pair of the second portions in the front-rear direction. Therefore, compared to a case where each adjacent pair of the second portions in the front-rear direction is spaced apart from each other in the connection portion with the respective third portion, the load can be distributed efficiently, and it is thus effective to protect the floor section during the side collision.

In the vehicle lower structure according to the above aspect, such a configuration may be adopted that the paired third portions are respectively fixed to the paired side sills.

In the vehicle lower structure according to the above aspect, since the third portion is fixed to the side sill, the load input to the side sill during the side collision is efficiently transmitted to the third portion.

In the vehicle lower structure according to the above aspect, such a configuration may be adopted that at least some of the plural first portions and the plural second portions each have: paired side wall portions that are formed to extend along the vehicle width direction on both sides in the front-rear direction; and a rib that is formed to connect between the paired side wall portions.

In the vehicle lower structure according to the above aspect, since at least some of the plural first portions and the plural second portions have the rib that connects the side wall portions, a weight reduction and high rigidity against the load are simultaneously achieved in comparison with a case where the rib is not provided. Therefore, it is further effective to protect the floor section during the side collision while weight of the vehicle is reduced.

In the vehicle lower structure according to the above aspect, such a configuration may be adopted that the plural second portions include: portions, each of which extends obliquely forward to the outer side in the vehicle width direction from respective one of connection portions with the first portions; and portions, each of which extends obliquely rearward to the outer side in the vehicle width direction from respective one of the connection portions with the first portions, and the portions extending obliquely forward and the portions extending obliquely rearward are alternately arranged in the front-rear direction.

In the vehicle lower structure according to the above aspect, since the portions extending obliquely forward and the portions extending obliquely rearward are alternately arranged in the front-rear direction, the load that is input to the side sill during the side collision is axially transmitted to each of the second portions, and is also axially transmitted to the first portions connected to the second portions. Therefore, in the vehicle lower structure according to the above aspect, even when the side collision load is input to the side sill from the portion within the wider area than that in the above related art, the load can be axially transmitted to the first portions.

In the vehicle lower structure according to the above aspect, such a configuration is adopted that each adjacent pair of the portion extending obliquely forward and the portion extending obliquely rearward in the front-rear direction is connected to each other in the connection portion with the respective first portion.

In the vehicle lower structure according to the above aspect, since each adjacent pair of the portion extending obliquely forward and the portion extending obliquely rearward in the front-rear direction is connected to each other in the connection portion with the respective first portion, the load that is axially transmitted to the second portion is highly efficiently transmitted to the first portion.

In the vehicle lower structure according to the above aspect, such a configuration may be adopted that the frame member further includes paired fourth portions, each of which extends in the front-rear direction and is disposed to connect the connection portions between the plural first portions and the plural second portions.

In the vehicle lower structure according to the above aspect, since the frame member further includes the paired fourth portions, each of which connects the connection portions between the plural first portions and the plural second portions, the load that is transmitted to the second portions is also distributed to the adjacent first portions by the fourth portion. Therefore, in the lower structure according to the above aspect, it is possible to further effectively protect the floor section during the side collision.

In the vehicle lower structure according to the above aspect, such a configuration may be adopted that each of the plural second portions is formed such that a width thereof in the front-rear direction is gradually increased outward in the vehicle width direction from the connection portion with the respective first portion.

In the vehicle lower structure according to the above aspect, each of the plural second portions is formed such that the width thereof in the front-rear direction is gradually increased outward in the vehicle width direction from the connection portion with the respective first portion. Thus, even when the side collision load is input to the side sill from the portion within the wider area than that in the above related art, the input load is efficiently transmitted from the third portion to the second portions. Therefore, in the vehicle lower structure according to the above aspect, it is possible to sufficiently protect the floor section during the side collision.

In the vehicle lower structure according to the above aspect, such a configuration may be adopted that the frame member is formed integrally.

In the vehicle lower structure according to the above aspect, since the frame member is formed integrally, the number of the components can be reduced in comparison with a case where the portions are formed by separate members. Therefore, it is possible to reduce manufacturing cost from a viewpoint of reducing man-hours for component management at the time of manufacturing and a viewpoint of reducing man-hours for connecting the portions.

In the vehicle lower structure according to the above aspect, such a configuration may be adopted that each of the paired side sills has an outer side sill that is disposed on the outer side in the vehicle width direction and an inner side sill that is disposed on the inner side in the vehicle width direction and is fixed to the outer side sill, and of the outer side sill and the inner side sill that constitute the respective side sill, at least the inner side sill is integrally formed with the frame member.

In the vehicle lower structure according to the above aspect, of the outer side sill and the inner side sill that constitute the side sill, at least the inner side sill is integrally formed with the frame member. Thus, compared to a case where the inner side sill is formed by a different member from the frame member, the number of the components can be reduced. Therefore, it is possible to reduce the manufacturing cost from the viewpoint of reducing the man-hours for the component: management at the time of manufacturing and the viewpoint of reducing the man-hours for fixing the frame member and the inner side sill.

### Advantageous Effects

In the vehicle lower structure according to each of the above aspects, the floor section can be protected even when the obstacle such as the pole collides from the side.

### BRIEF DESCRIPTION OF DRAWINGS

FIG. 1 is a plan view illustrating a partial configuration of a vehicle, to which a lower structure according to a first embodiment is applied.

FIG. 2 is a plan view illustrating ribs that are provided in a first portion and a second portion of a frame member.

FIG. 3 is a cross-sectional view illustrating a cross section that is taken along line III-III in FIG. 2.

FIG. 4 is a cross-sectional view illustrating a configuration of a rib according to a first modified example.

FIG. 5 is a cross-sectional view illustrating a configuration of a rib according to a second modified example.

FIG. 6 is a cross-sectional view illustrating a joint structure of the frame member to a side sill.

FIG. 7 is a schematic view illustrating a transmission path of a load during a side collision.

FIG. 8 is a plan view illustrating a partial configuration of a vehicle, to which a lower structure according to a second embodiment is applied.

FIG. 9 is a plan view illustrating a lower structure of a vehicle according to the related art.

### DESCRIPTION OF EMBODIMENTS

A description will hereinafter be made on embodiments with reference to the drawings. The disclosure will be exemplified in the embodiments described below, and the disclosure is not limited to the following embodiments except for an essential configuration thereof.

In the drawings used in the following description, “FR” indicates a vehicle front direction, “RR” indicates a vehicle rear direction, “LH” indicates a vehicle left direction, “RH” indicates a vehicle right direction, “UP” indicates a vehicle up direction, and “LO” indicates a vehicle down direction.

### First Embodiment

### 1. Configuration of Vehicle 1

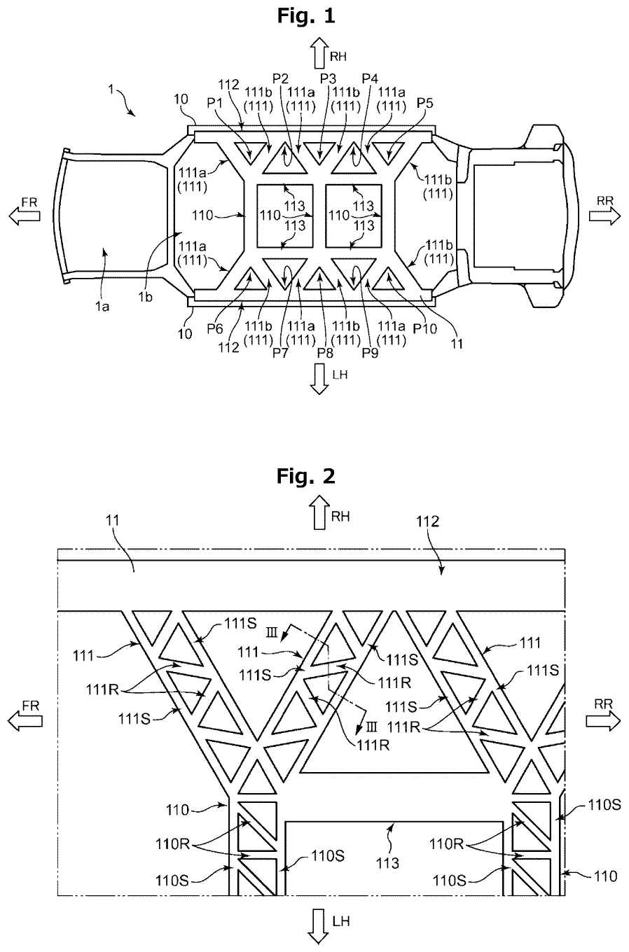

A description will be made on a partial configuration of a vehicle 1, to which a lower structure according to a first embodiment is applied, with reference to FIG. 1. FIG. 1 only extracts and illustrates a part of the lower structure of the vehicle 1, and does not illustrate a power train and the like.

As illustrated in FIG. 1, the vehicle 1 includes a powertrain mounting section 1a in which the powertrain is mounted on a front portion, and includes a floor section 1b as an area that is located behind the powertrain mounting section 1a and in which an occupant rides. The floor section 1b includes paired side sills 10 and a frame member 11.

The paired side sills 10 are disposed on both sides in a vehicle width direction of the floor section 1b and are each formed to extend in a front-rear direction. The frame member 11 is disposed between the paired side sills 10 in a manner to connect the side sill 10 on a vehicle left side and the side sill 10 on a vehicle right side.

The frame member 11 has plural first portions 110, plural second portions 111, paired third portions 112, and paired fourth portions 113. In a central portion in the vehicle width direction of the floor section 1b, the plural (three as an example) first portions 110 are disposed at mutually-spaced intervals in the front-rear direction and are each formed to extend in the vehicle width direction.

The plural (12 as an example) second portions 111 are each connected to the respective first portion 110, are each formed to extend outward in the vehicle width direction, and are arranged in the front-rear direction.

The paired third portions 112 are each connected to the plural second portions 111 on an outer side in the vehicle width direction, are each formed to extend in the front-rear direction along the respective side sill 10, and are each fixed to the respective side sill 10.

The paired fourth portions 113 each extend in the front-rear direction and are disposed to connect connection portions P1, P3, P5, P6, P8, P10 between the plural first portions 110 and the plural second portions 111.

Each of the plural first portions 110, the plural second portions 111, the paired third portions 112, and the paired fourth portions 113 is a long frame portion. In the present embodiment, the plural first portions 110, the plural second portions 111, the paired third portions 112, and the paired fourth portions 113 are formed integrally. For example, a casting method can be adopted as a method for forming the frame member 11.

The plural second portions 111 include: portions 111a, each of which extends obliquely forward to the outer side in the vehicle width direction from respective one of the connection portions P1, P3, P5, P6, P8, P10 with the first portions 110; and portions 111b, each of which extends obliquely rearward to the outer side in the vehicle width direction from respective one of the connection portions P1, P3, P5, P6, P8, P10 with the first portions 110. In the front-rear direction, the portions 111a, each of which extends obliquely forward, and the portions 111b, each of which extends obliquely rearward, are alternately arranged.

In regard to the second portions 111 in an intermediate portion in the front-rear direction (the second portions 111 excluding the portions 111a arranged on the foremost side and the portions 111b arranged on the rearmost side) of the plural second portions 111, each adjacent pair of the second portions 111 in the front-rear direction is connected to each other in respective one of connection portions P2, P4, P7, P9 with the third portions 112 without being spaced apart from each other front-rear direction.

Furthermore, of the plural second portions 111, each adjacent pair of the second portions 111 in the front-rear direction is connected to each other in respective one of the connection portions P1, P3, P5, P6, P8, P10 with the first portions 110 and the fourth portions 113 without being spaced apart from each other in the front-rear direction.

### 2. Detailed Configurations of First Portion 110 and Second Portion 111 in Frame Member 11

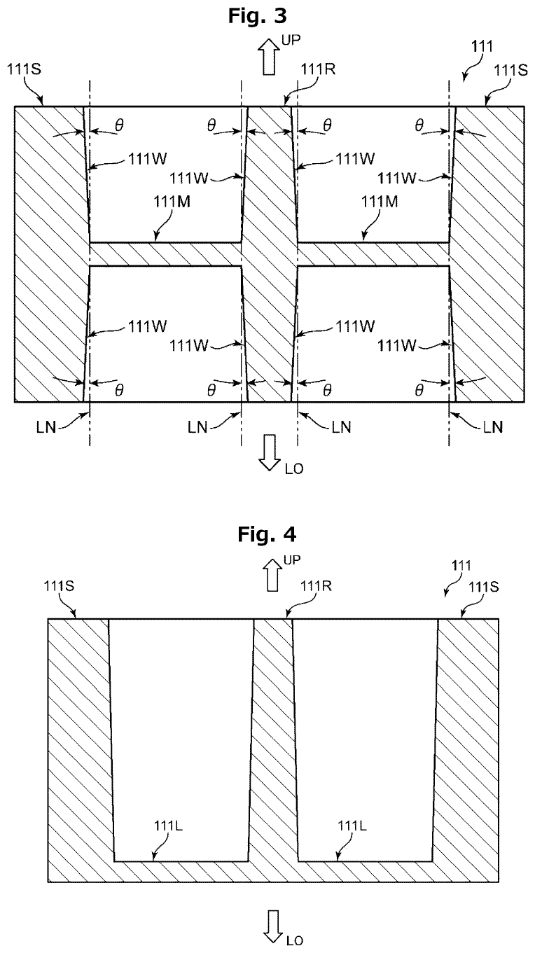

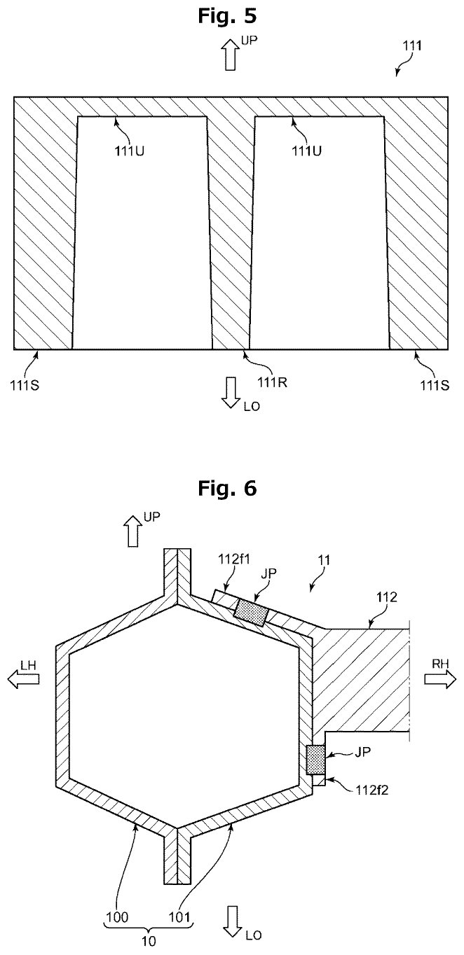

A description will be made on detailed configurations of the first portions 110 and the second portions 111 in the frame member 11 with reference to FIG. 2 to FIG. 5. FIG. 2 is a plan view illustrating ribs 110R, 111R that are respectively included in the first portions 110 and the second portions 111 in the frame member 11. FIG. 3 is a cross-sectional view illustrating a cross section that is taken along line III-III in FIG. 2, and FIG. 4 and FIG. 5 each illustrate a modified example.

As illustrated in FIG. 2, at least some of the plural first portions 110 and the plural second portions 111 in the frame member 11 have a pair of side wall portions 110S, 111S and ribs 110R, 111R. In the present embodiment, as an example, all of the first portions 110 have the pair of side wall portions 110S and the ribs 110R, and all of the second portions 111 have the pair of side wall portions 111S and the ribs 111R.

In the first portion 110, the paired side wall portions 110S are each formed to extend in the vehicle width direction, and are formed to oppose each other in the front-rear direction. In the second portion 111, the paired side wall portions 111S are each formed to extend in an oblique direction that is inclined with respect to the vehicle width direction and the front-rear direction, and are formed to oppose each other in a direction orthogonal to the extending direction.

In the first portion 110, the plural ribs 110R are formed to connect between the paired side wall portions 110S in the first portion 110. In the second portion 111, the plural ribs 111R are formed to connect the paired side wall portions 111S in the second portion 111.

As illustrated in FIG. 3, in an intermediate portion in an up-down direction, each of the plural second portions 111 in the present embodiment has an intermediate base 111M that connects the pair of side wall portions 111S, and the rib 111R is provided to rise in both directions of the up-down direction with the intermediate base 111M as a starting point. Side wall surfaces 111W of the pair of side wall portions 111S and side wall surfaces 111W of the rib 11R are each formed to have a draft angle θ with respect to an imaginary line LN drawn in a vertical direction.

Although not illustrated, the plural first portions 110 each have the same configuration as that illustrated in FIG. 3.

However, each of the plural first portions 110 and the plural second portions 111 may have a configuration as illustrated in FIG. 4 or FIG. 5. More specifically, as illustrated in FIG. 4, the plural second portions 111 in a first modified example may each have, in a lower portion, a lower base 111L that connects the paired side wall portions 111S, and the rib 111R may be provided to rise upward with the lower base 111L as a starting point. The plural first portions 110 may each have the same configuration as that illustrated in FIG. 4.

Furthermore, as illustrated in FIG. 5, the plural second portions 111 in a second modified example may each have, in an upper portion, an upper base 111U that connects the paired side wall portions 111S, and the rib 111R may be provided to be hung downward with the upper base 111U as a starting point. Each of the plural first portions 110 may each have the same configuration as that illustrated in FIG. 5.

### 3. Fixed Structure of Frame Member 11 to Side Sill 10

A description will be made on a fixed structure of the frame member 11 to the side sill 10 with reference to FIG. 6. FIG. 6 is a cross-sectional view illustrating the side sill 10 disposed on the left side and a part of the third portion 112 in the frame member 11.

As illustrated in FIG. 6, the side sill 10 of the vehicle 1 according to the present embodiment is formed by a combination of an outer side sill 100 and an inner side sill 101. The outer side sill 100 is a portion that is disposed on the outer side in the vehicle width direction. The inner side sill 101 is a portion that is disposed on the inner side in the vehicle width direction.

The outer side sill 100 and the inner side sill 101 each have a hat-like cross-sectional shape, and constitute the side sill 10 having a closed cross-sectional structure by fixing flange portions thereof to each other.

The third portion 112 in the frame member 11 has: a flange portion 112f1 that is formed along a part of an upper surface of the inner side sill 101; and a flange portion 112f2 that is formed along a part of an inner surface of the inner side sill 101.

The flange portions 112f1, 112f2 of the third portion 112 are each fixed to the inner side sill 101 in a fixed portion JP. In this way, the frame member 11 is fixed to the side sill 10. A method for fixing the third portion 112 to the inner side sill 101 is not particularly limited. However, for example, fastening using a bolt or a rivet, resistance welding, laser welding, or the like can be employed.

In the present embodiment, the outer side sill 100 and the inner side sill 101 are separate members from the frame member 11, but at least the inner side sill 101 may be integrally formed with the frame member 11.

### 4. Relationship Between Second Portions 111 and First Portions 110

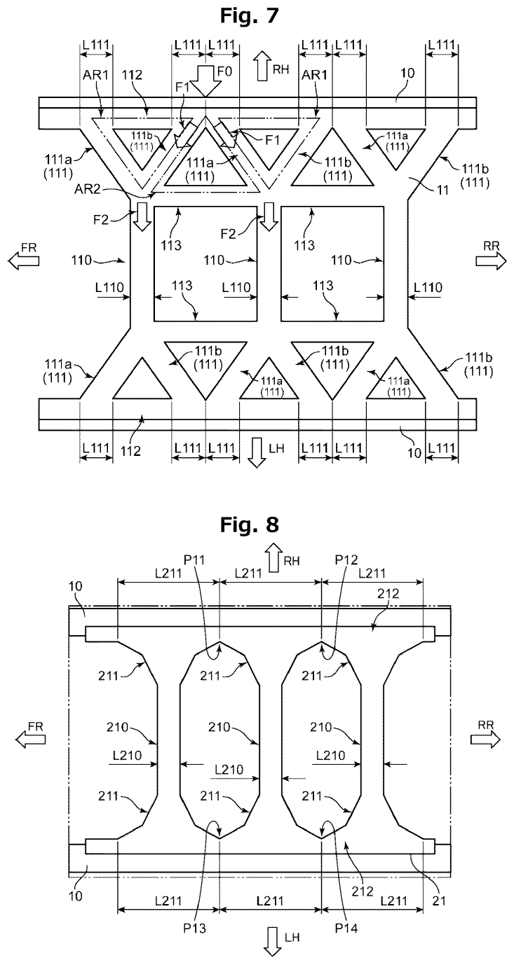

A description will be made on a relationship between the second portion 111 and the first portion 110 of the frame member 11 with reference to FIG. 7. FIG. 7 is a plan view in which the side sills 10 and the frame member 11 are seen from above.

As illustrated in FIG. 7, in the present embodiment, the first portions 110, the second portions 111, the third portions 112, and the fourth portions 113 each have an elongated pillar shape. In the present embodiment, as an example, widths of the portions 110 to 113 are uniform in a longitudinal direction.

The first portions 110 each have a length (width) L110 in the front-rear direction. However, the lengths L110 of the plural first portions 110 in the front-rear direction may differ from each other.

An outer end portion in the vehicle width direction of each of the second portions 111 has a length L111. However, the lengths L111 of the end portions of the plural second portions 111 in the front-rear direction may differ from each other.

In the present embodiment, the plural first portions 110 and the plural second portions 111 are formed to satisfy the following relationship.

6×L111>3×L110 (Expression 1)

That is, in the present embodiment, the plural second portions 111 are formed such that a total length (6×L111) in the front-rear direction of the end portions on each of both of the outer sides (each of the right and left sides) in the vehicle width direction is longer than a total length (3×L110) in the front-rear direction of the plural first portions 110.

### 5. Arrangement of Second Portions 111, Third Portions 112, and Fourth Portions 113

A description will be made on arrangement of the second portions 111, the third portions 112, and the third portions 113 of the frame member 11 with reference to FIG. 7.

As illustrated in FIG. 7, the third portion 112 and the fourth portion 113 are arranged side by side with a space being provided therebetween in the vehicle width direction. As described above, the second portions 111 include the portions 111a extending obliquely forward and the portions 111b extending obliquely rearward, and the portions 111a and the portions 111b are alternately arranged in the front-rear direction.

When the portion 111a, which extends obliquely forward, and the portion 111b, which is arranged behind the portion 111a and extends obliquely rearward, are extracted, in the frame member 11, the portion 111a, the portion 11b, and the third portion 112 constitute a structure (triangular structure) AR1 having a triangular shape in a plan view.

When the portion 11b, which extends obliquely rearward, and the portion 111a, which is arranged behind the portion 11b and extends obliquely forward, are extracted, in the frame member 11, the portion 111b, the portion 111a, and the fourth portion 113 constitute a structure (triangular structure) AR2 having a triangular shape in the plan view.

Each of the triangular structures AR1, AR2 is a portion that has a similar structure to a so-called truss structure in a point of having a triangular hollow portion therein in the plan view. However, in the frame member 11 of the present embodiment, each node between the second portion 111 and each of the third portion 112 and the fourth portion 113 is not fastened by a bolt or a rivet, and the portions 111 to 113 are integrally connected at each of the nodes.

The frame member 11 in the present embodiment has a configuration that the triangular structures AR1 and the triangular structures AR2 are alternately arranged in the front-rear direction on both of the outer sides in the vehicle width direction of the first portions 110, each of which extends in the vehicle width direction.

### 6. Effects

In the vehicle 1, to which the lower structure according to the present embodiment is applied, the frame member 11 having the plural first portions 110 and the plural second portions 111 is disposed between the paired side sills 10. The plural second portions 111 are formed such that the total length (6×L111) in the front-rear direction of the end portions on each of both of the outer sides in the vehicle width direction is longer than the total length (3×L110) in the front-rear direction of the plural first portions 110. Thus, as may be seen in FIG. 7, even when a side collision load F0 is input to the side sill 10 from a portion within a wider range than that in the above related art, as indicated by arrows F1, F2, the input side collision load F0 is efficiently transmitted to the first portions 110 via the second portions 111.

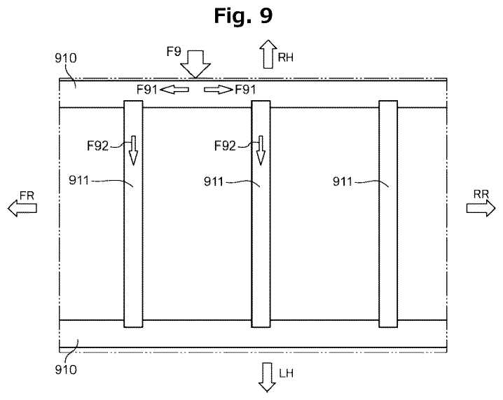

That is, in the vehicle 1, to which the lower structure according to the present embodiment is applied, unlike the related art illustrated in FIG. 9 in which the cross member 911 is directly connected to the side sill 910, the second portions 111 are connected to the respective side sill 10 within a wider area in the front-rear direction than the first portions 110. Accordingly, even when the side collision load F0 is input to the side sill 10 from the portion within the wider area than that in the above related art, the input side collision load F0 is transmitted to the first portions 110 via the second portions 111 and is then distributed to the second portions 111 on the opposite side from the load input side. Therefore, in the vehicle 1, the floor section 1b can be protected sufficiently even when an obstacle such as a pole collides from the side.

In the vehicle 1, to which the lower structure according to the present embodiment is applied, the frame member 11 has the third portions 112, each of which is disposed along the respective side sill 10 and is disposed between the second portions 111 and the respective side sill 10. Accordingly, the collision load F0, which is input to the side sill 10 during the side collision, is distributed to the third portion 112 in both of the front direction and the rear direction, and is then efficiently transmitted to the second portions 111.

In the vehicle 1, to which the lower structure according to the present embodiment is applied, each adjacent pair of the second portions 111 in the front-rear direction is connected to each other in respective one of the connection portions P2, P4, P7, P9 with the third portion 112. Thus, the side collision load that is input from the side sill 10 to the third portion 112 can be distributed highly efficiently to the second portions 111 that are adjacent to each other in the front-rear direction. Therefore, compared to a case where each adjacent pair of the second portions 111 in the front-rear direction is spaced apart from each other in respective one of the connection portions P2, P4, P7, P9 with the third portions 112, the load can be distributed efficiently, and it is thus effective to protect the floor section 1b during the side collision.

In the vehicle 1, for which the lower structure according to the present embodiment is adopted, as illustrated in FIG. 6, since the third portion 112 is fixed to the side sill 10, the collision load F0, which is input to the side sill 10 during the side collision, is efficiently transmitted to the third portion 112.

In the vehicle 1, for which the lower structure according to the present embodiment is adopted, since the plural first portions 110 and the plural second portions 111 have the ribs 110R, 111R that connect the side wall portions 110, 111S, respectively, a weight reduction and high rigidity against the collision load are simultaneously achieved in comparison with a case where the ribs 110R, 111R are not provided. Therefore, it is further effective to protect the floor section 1b during the side collision while weight of the vehicle 1 is reduced.

In the vehicle 1, for which the lower structure according to the present embodiment is adopted, the second portions 111 have the portions 111a extending obliquely forward and the portions 111b extending obliquely rearward, the portions 111a and the portions 111b being alternately disposed in the front-rear direction. Accordingly, the side collision load F0, which is input to the side sill 10 during the side collision, is transmitted as an axial force to each of the second portions 111, and is also axially transmitted to the first portions 110 that are respectively connected to the second portions 111. Therefore, in the vehicle 1, even when the side collision load F0 is input to the side sill 10 from the portion within the wider area than that in the above related art, the side collision load F0 can be axially transmitted to the first portions 110.

In the vehicle 1, to which the lower structure according to the present embodiment is applied, each adjacent pair of the portion 111a extending obliquely forward and the portion 111b extending obliquely rearward in the front-rear direction is connected to each other in respective one of the connection portions P1, P3, P5, P6, P8, P10 with the first portions 110. Therefore, the load that is axially transmitted to the second portions 111 is highly efficiently transmitted to the first portions 110.

In the vehicle 1, to which the lower structure according to the present embodiment is applied, since the frame member 11 further has the paired fourth portions 113 that connect the connection portions P1, P3, P5, P6, P8, P10 between the plural first portions 110 and the plural second portions 111, the load that is transmitted to the second portions 111 is also distributed to the adjacent first portions 110 in the front-rear direction by the fourth portions 113. Therefore, in the lower structure according to the present embodiment, it is possible to further effectively protect the floor section 1b during the side collision.

In the vehicle 1, to which the lower structure according to the present embodiment is applied, since the plural first portions 110, the plural second portions 111, the pair of third portions 112, and the pair of fourth portions 113 are formed integrally, the number of the components can be reduced in comparison with a case where the portions 110 to 113 are formed by separate members. Therefore, it is possible to reduce manufacturing cost from a viewpoint of component management at the time of manufacturing.

As it has been described so far, in the vehicle 1, to which the lower structure according to the present embodiment is applied, the floor section 1b can be protected sufficiently even when the obstacle such as the pole collides from the side.

### Second Embodiment

A description will be made on a configuration of a vehicle, to which a lower structure according to a second embodiment is applied, with reference to FIG. 8. The vehicle, to which the lower structure according to the present embodiment is applied, has the same configuration as that in the above first embodiment except for a configuration of a frame member 21. Thus, the following description will be made on the configuration of the frame member 21 as a different point from the above first embodiment.

As illustrated in FIG. 8, the frame member 21 in the present embodiment has plural (three as an example) first portions 210, plural (six as an example) second portions 211, and a pair of third portions 212. Similar to the plural first portions 110 in the above first embodiment, the plural first portions 210 are disposed at mutually-spaced intervals in the front-rear direction, in the central portion of the floor section 1b in the vehicle width direction, and are each formed to extend in the vehicle width direction.

Similar to the pair of third portions 112 in the above first embodiment, the paired third portions 212 are each connected to the plural second portions 211 on the outer side in the vehicle width direction, are each formed to extend in the front-rear direction along the respective side sill 10, and are each fixed to the respective side sill 10.

The plural second portions 211 are each connected to the respective first portion 210 and each formed in a fan shape such that a width thereof in the front-rear direction is gradually increased outward in the vehicle width direction from a connection portion with the respective first portion 210. On each of the outer sides in the vehicle width direction, the plural second portions 211 are arranged side by side in the front-rear direction.

The plural first portions 210, the plural second portions 211, and the pair of the third portions 212 are formed integrally. Similar to the above first embodiment, for example, the casting method can be adopted as a method for forming the frame member 21.

Of the plural second portions 211, each adjacent pair of the second portions 211 in the front-rear direction is connected to each other in respective one of connection portions P11 to P14 with the second portions 212 without being spaced apart from each other in the front-rear direction.

In the present embodiment, the first portions 210 and the third portions 212 each have an elongated pillar shape. Also, in the present embodiment, as an example, widths of the first portions 210 and the third portions 212 are uniform in the longitudinal direction.

The first portions 210 each have a length (width) L210 in the front-rear direction. However, the lengths L210 of the plural first portions 210 in the front-rear direction may differ from each other.

An outer end portion in the vehicle width direction of each of the second portions 211 (a connection length with the third portion 212) has a length L211. However, the lengths L211 of the end portions of the plural second portions 211 in the front-rear direction may differ from each other.

In the present embodiment, the plural first portions 210 and the plural second portions 211 are formed to satisfy the following relationship.

3×L211>3×L210 (Expression 2)

That is, also in the present embodiment, the plural second portions 211 are formed such that a total length (3×L211) in the front-rear direction of the end portions on each of both of the outer sides (each of the right and left sides) in the vehicle width direction is longer than a total length (3×L210) in the front-rear direction of the plural first portions 210.

In the vehicle, for which the lower structure according to the present embodiment is adopted, the structure of the frame member 21 differs from that in the above first embodiment. However, since the frame member 21 is configured to satisfy the above relational expression 2, it is possible to exert the same effects as those in the above first embodiment. That is, also in the lower structure according to the present embodiment, each of the plural second portions 211 is formed such that the width thereof in the front-rear direction is gradually increased outward in the vehicle width direction from the connection portion with the respective first portion 210. Thus, even when the side collision load is input to the side sill 10 from the portion within the wider area than that in the above related art, the load is efficiently transmitted from the third portion 212 to the second portions 211. Therefore, also in the lower structure according to the present embodiment, it is possible to sufficiently protect the floor section during the side collision.

Also, in the present embodiment, similar to the above first embodiment, such a configuration may be adopted that at least some of the plural first portions 210 and the plural second portions 211 each have a pair of side wall portions and ribs.

### Other Modified Examples

In the above first embodiment, the frame member 11 has the third portions 112 and the fourth portions 113. In the above second embodiment, the frame member 21 has the third portions 212. Alternatively, where the frame member does not have the third portion, each of the second portions may be fixed to the respective side sills.

In the above first embodiment and the above second embodiment, such a structure is adopted that the third portions 112, 212 of the frame members 11, 21 are directly fixed to the side sills 10. However, another member may be interposed between the third portion and the side sill. As long as the collision load input to the side sill is transmitted to the frame member, any of various connection structures can be adopted.

In the above first embodiment, the second portions 111 of the frame member 11 have the portions 111a extending obliquely forward and the portions 111b extending obliquely rearward. However, the disclosure is not limited thereto. For example, the second portions may only have the portions extending obliquely forward or may only have the portions extending obliquely rearward.

In the above second embodiment, the second portion 211 of the frame member 21 has a planar shape that is formed by combining two trapezoidal portions. However, the disclosure is not limited thereto. For example, it may have a shape that the length (the width) in the front-rear direction is increased exponentially or increased quadratically in the plan view.

In the above first embodiment, the first portions 110 and the second portions 111 of the frame member 11 have the side wall portions 110S, 111S and the ribs 110R, 111R, respectively. However, the disclosure is not limited thereto. Each of the first portion and the second portion may be a portion having a solid rod shape and may not have the ribs. Alternatively, only some of the plural first portions and the plural second portions may have the ribs.

In the above first embodiment and the above second embodiment, the frame members 11, 21 are each formed integrally. However, the disclosure is not limited thereto. For example, the first portion and the second portion may be fastened by the bolt or the rivet or may be welded.

The frame member does not always have to be formed by using a metal material. For example, the frame member may be formed by using a fiber-reinforced resin material (such as CFRP or GFRP) or may be formed by using a composite of a resin material (including the fiber-reinforced d resin material) and the metal material.

In the above first embodiment and the above second embodiment, sizes in the up-down direction of the frame members 11, 21 are not particularly described. However, various changes can be made to the sizes in the up-down direction. For example, the size of the frame member in the up-down direction may differ for each region in the front-rear direction or the vehicle width direction or may differ in the first portion and the second portion.

In the above first embodiment and the above second embodiment, a floor panel is not described. However, the floor panel can be formed integrally as a part of the frame member, or the floor panel can be fixed to the frame member.

### REFERENCE SIGNS LIST

1: vehicle
1b: floor section
10: side sill
11, 12: frame member
110, 210: first portion
110R: rib
111, 211: second portion
111R: rib
112, 212: third portion

1. A lower structure of a floor section in a vehicle, the vehicle lower structure comprising:
paired side sills on both sides in a vehicle width direction of the floor section, each side sill extending in a front-rear direction; and
a frame member between the paired side sills, wherein
the frame member includes:
plural first portions at spaced intervals in the front-rear direction in a central portion in the vehicle width direction of the floor section, and are each formed to extend in the vehicle width direction; and
plural second portions, each second portion being connected to an end portion of a respective first portion, extends outward in the vehicle width direction, and is arranged in the front-rear direction, and
the plural second portions have a total length in the front-rear direction of end portions on each outer side in the vehicle width direction is longer than a total length in the front-rear direction of the plural first portions.

2. The vehicle lower structure according to claim 1, wherein
the frame member further includes paired third portions, each third portion being connected to the end portions of the plural second portions on the outer side in the vehicle width direction, extends in the front-rear direction along a respective side sill, and being connected to the respective side sill.

3. The vehicle lower structure according to claim 2, wherein
each adjacent pair of second portions in the front-rear direction is connected to each other in a connection portion with a respective third portion.

4. The vehicle lower structure according to claim 2, wherein
the paired third portions are respectively fixed to the paired side sills.

5. The vehicle lower structure according to claim 2, wherein
at least some of the plural first portions and the plural second portions each have:
paired side wall portions that extend along the vehicle width direction on both sides in the front-rear direction; and
a rib between the paired side wall portions.

6. The vehicle lower structure according to claim 2, wherein
the plural second portions include:
forward portions, each forward portions extends obliquely forward to the outer side in the vehicle width direction from a respective connection portion with the first portions; and
rearward portions, each rearward portion extends obliquely rearward to the outer side in the vehicle width direction from the respective connection portion with the first portions, and
the forward and reward portions are alternately arranged in the front-rear direction.

7. The vehicle lower structure according to claim 6, wherein
each adjacent pair of forward and rearward portions is connected to each other in the respective connection portion with the respective first portion.

8. The vehicle lower structure according to claim 2, wherein
the frame member further includes paired fourth portions,
each fourth portion extends in the front-rear direction and connects the connection portion between the plural first portions and the plural second portions.

9. The vehicle lower structure according to claim 2, wherein
each of the plural second portions has a width thereof in the front-rear direction that gradually increases outward in the vehicle width direction from the connection portion with the respective first portion.

10. The vehicle lower structure according to claim 2, wherein the frame member is an integral frame member.

11. The vehicle lower structure according to claim 1, wherein
each of the paired side sills includes:
an outer side sill on an outer side in the vehicle width direction; and
an inner side sill on an inner side in the vehicle width direction and fixed to the outer side sill, wherein
at least the inner side sill is integral with the frame member.

12. The vehicle lower structure according to claim 1, wherein
at least some of the plural first portions and the plural second portions each have:
paired side wall portions that extend along the vehicle width direction on both sides in the front-rear direction; and
a rib between the paired side wall portions.

13. The vehicle lower structure according to claim 12, wherein the paired side wall portions are connected by an intermediate base and the rib extends from the intermediate base in both an up direction and a down direction.

14. The vehicle lower structure according to claim 12, wherein the paired side wall portions are connected by an upper base and the rib extends from the upper base in a down direction.

15. The vehicle lower structure according to claim 12, wherein the paired side wall portions are connected by a lower base and the rib extends from the lower base in both an up direction.

16. The vehicle lower structure according to claim 1, wherein
the plural second portions include:
forward portions, each forward portion extends obliquely forward to the outer side in the vehicle width direction from a respective connection portion with the first portions; and
rearward portions, each rearward portion extends obliquely rearward to the outer side in the vehicle width direction from the respective connection portion with the first portions, and
the forward and reward portions are alternately arranged in the front-rear direction.

17. The vehicle lower structure according to claim 16, wherein
each adjacent pair of forward and rearward portions is connected to each other in a connection portion with the respective first portion.

18. The vehicle lower structure according to claim 1, wherein
the frame member further includes paired fourth portions,
each fourth portion extends in the front-rear direction and connects a connection portion between the plural first portions and the plural second portions.

19. The vehicle lower structure according to claim 1, wherein
each second portion has a width in the front-rear direction that gradually increases outward in the vehicle width direction from a connection portion with the respective first portion.

20. The vehicle lower structure according to claim 1, wherein the frame member is an integral frame member.
